(19) United States
(12) Patent Application Publication
(10) Pub. No.: US 2005/0097237 A1
(43) Pub. Date: May 5, 2005

(54) Line-conducted interface arrangement and a method for operating a line-conducted interface arrangement between a host and a device

(75) Inventors: Stefan Ruping, Lengdorf (DE); Kalman Cinkler, Munchen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/952,472

(22) Filed: Sep. 27, 2004

(30) Foreign Application Priority Data
Sep. 26, 2003 (DE) 103 44 852.7

(51) Int. Cl. G06F 3/00

(52) U.S. Cl. 710/15

(57) ABSTRACT

Line-conducted interface arrangement having at least three signal lines connected between a host and a device, a detector which is connected to the signal lines at a device end of the interface arrangement and which detects an interface configuration prescribed at the host, and a switch controlled by the detector to adapt the device to the interface configuration prescribed at the host.

### CROSS-REFERENCE TO RELATED APPLICATION

This application claims priority to German Patent Application Serial No. 10344852.7, which was filed Sep. 26, 2003, and which is incorporated herein by reference in its entirety.

### FIELD OF THE INVENTION

The invention relates to a line-conducted interface arrangement and to a method for operating such a line-conducted interface arrangement between a host and a device.

### BACKGROUND OF THE INVENTION

In many areas of technology, special interface standards have developed so that electronic devices can communicate among one another or with other devices. In this case, PC technology includes, for example, V.24, RS232, for the connection of printers and external devices to a PC, or for example the SCSI standard as an interface in order to install additional plug-in cards in a PC. One of the newest standards in PC technology, which has become very widespread in the meantime, is the USB standard, which makes it possible, by means of a serial data transmission, to permit external devices to communicate with a host with a comparatively high transmission rate in which case in accordance with this standard, the connection can be established during switched-on operation of the host. The interface according to ISO 7816, inter alia, has gained acceptance in the field of smart card technology. This interface is used for a wide variety of smart cards comprising contacts, both for the telephone card that has been known for a very long time, the widespread medical insurance card, and the cash card that is being used to an increasing extent.

Even though the costs of procuring smart cards on an individual basis are comparatively low in relation to other electronic devices, the card readers that have become very widespread in the meantime, and are referred to as “terminals”, afford significant values that one would not necessarily wish to replace quickly by other devices. In the area of smart cards, there is now a desire to provide the data exchange with the latter with a transmission rate that is higher than that according to the currently customary ISO standard. In principle, by way of example, a data transmission in accordance with the USB standard would be appropriate for this purpose. In order not to replace all previous terminals by new terminals, it is appropriate either to effect retrofitting so that the terminals operate both according to the ISO 7816 standard and according to the USB standard. Furthermore, provision may be made for connecting smart cards directly to the USB interface in the future by means of a purely passive adapter, which may mean an advantage not only with regard to the procurement costs.

However, the problem that has been demonstrated for the area of smart cards also arises in a fundamental manner for other electronic devices which communicate with the outside world in accordance with a defined standard, and for which there is a desire to be able to operate them according to at least one further standard without providing a further interface with additional contacts or the like. In other words, it is true that the intention is for the mechanical configurations to be retained and the specifications with regard to protocol and electrical parameters from the additional standard to be applicable. A first solution in this field is disclosed in WO 00/16255 A1, in which it is proposed that the contacts C4 and C5 of the eight-contact smart card contact in accordance with ISO 7816, which is kept free for additional services, is provided for the lines D+ and D− in accordance with the USB standard. For the six-contact ISO connection, the contacts C3 and C7 are provided for the USB data lines D+ and D−. The solution presented here has the disadvantage that it is stipulated from the outset that the terminal is provided for the USB standard, and that precisely the use of the contacts is prescribed.

### SUMMARY OF THE INVENTION

The invention is based on an object of providing an interface arrangement and a method for operating such an interface arrangement with line-conducted interfaces in the case of which operation according to at least two standards is possible with a low outlay and high flexibility.

By virtue of the fact that a detection device is provided, which determines an interface configuration at the host end on the at least three signal lines, the matching interface configuration at the device end can be set by means of the setting device.

By virtue of the fact that the detection device monitors at least two predetermined lines for the transmission of a first and a second operating potential, the standard provided at the host end can advantageously be determined by means of the temporal reference between the rise in an operating potential with respect to the occurrence of a reset signal. By virtue of the fact that the detection device can furthermore be used to check the resistance value with which the signal lines are terminated at the host end, it is possible to effect the functional assignment of the signal lines at the device end.

The measures specified preferably enable optional operation according to the ISO standard that is customary for smart cards and the USB standard.

### BRIEF DESCRIPTION OF THE DRAWINGS

The invention is described in detail below with reference to the figures in which:

FIG. 1 shows a basic illustration of the interface arrangement;

FIG. 2 shows details of the interface arrangement illustrated in FIG. 1;

FIG. 3 shows typical signal profiles of the interface lines in the case of the ISO standard;

FIG. 4 shows typical signal profiles of the interface lines when using the USB standard of a host having ISO and USB capability;

FIG. 5 shows signals on the interface lines of a host having only USB capability;

FIGS. 6a and 6b show smart card contacts in accordance with ISO 7816;

FIG. 7 shows signal line terminations at the host end and at the device end in the USB low-speed mode;

FIG. 8 shows signal line terminations at the host end and at the device end in the full-speed mode; and

FIG. 9 shows signal line terminations at the host end and at the device end in the USB high-speed mode.

### DETAILED DESCRIPTION OF THE PREFERRED MODE OF THE INVENTION

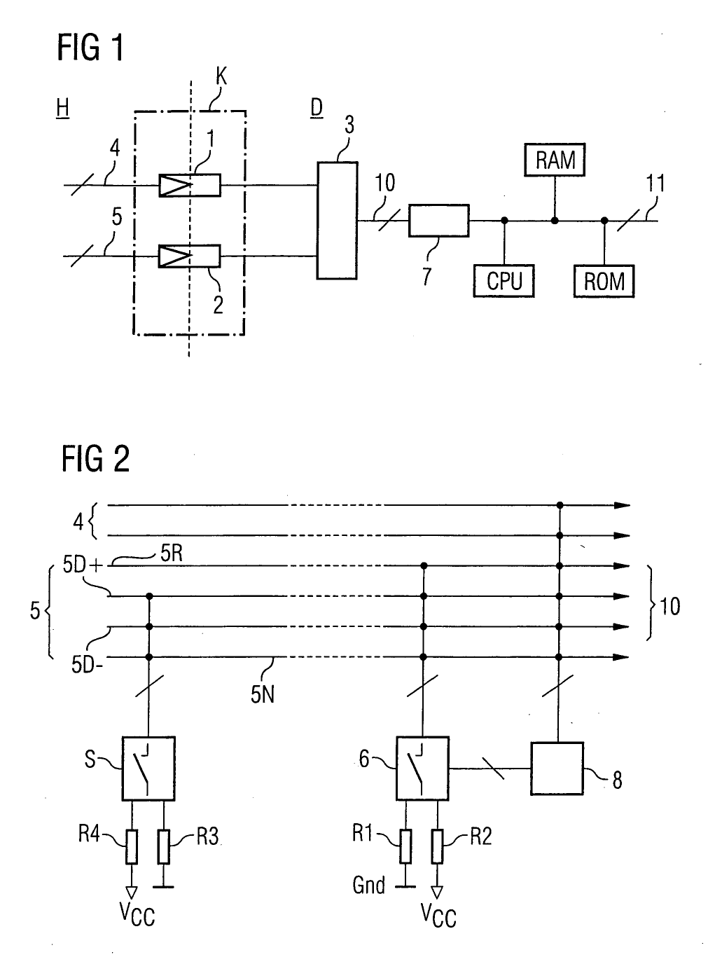

FIG. 1 illustrates an interface arrangement part H at the host end and an interface arrangement part D at the device end. Interface lines 4 and 5 are illustrated, a plurality of operating voltage lines 4 and a plurality of signal lines 5 being provided. In this case, operating voltage contacts 1 are provided for the operating voltage lines 4 and signal line contacts 2 are also provided for the signal lines 5, and they are connected to corresponding contacts connected to lines at the device end. The individual contacts are combined in a contact arrangement K. At the device end, both the operating voltage lines 4 and the signal lines 5 are fed to an interface circuit arrangement 3. At the device end, a device bus 11 is furthermore provided, which connects at least a CPU, a RAM and a ROM to one another and is likewise connected to an interface controller 7. The interface arrangement ensures that a correct assignment of the interface lines is provided in accordance with the standard. The interface controller 7 matches the functionality of the device D, in this case a smart card, to the interface standard set.

In accordance with FIG. 2, it is assumed that operation in accordance with two standards is provided both at the host end and at the device end. More specifically, this means that if, in accordance with one exemplary embodiment, a smart card is provided at the device end and a smart card reader, a so-called terminal, is provided at the host end, that both can be operated in accordance with the previously customary ISO standard for smart cards. At the same time it is assumed that both ends operate in accordance with the USB standard. For this purpose, two of the operating voltage lines 4 must transmit an operating voltage, that is to say that one line is provided for a first operating voltage potential and a second line is provided for a second operating voltage potential.

Furthermore two signal lines 5 are provided in accordance with the USB standard, representing signal lines D+ and D−. Since, in accordance with the exemplary embodiment at the host end a terminal is intended to be able to be operated both in the ISO smart card mode and in the USB mode, a signal line 5R of the signal lines 5 is provided for the transmission of a reset signal. Furthermore a signal line 5D+ and a signal line 5D− are provided which enable the data transmission in accordance with the USB standard. The signal lines 5D+ and 5D− and a signal line 5N that is not used any further are connected to a switching device S at the host end. The switching device S connects resistances R3 and R4 which are connected to the ground potential or to the operating potential in accordance with the respectively chosen operating mode of the USB standard, to the signal lines D+ and D− provided therefor. This will be explained in detail later with reference to FIGS. 7 to 9. Signal lines which are converted into an internal interface bus 10 are correspondingly provided at the device end.

A detector circuit 8 is connected to the signal lines 5 and determines, assuming that operation according to the USB standard is provided, which of the signal lines are the lines D+ and D− according to the USB standard.

FIGS. 7 to 9 are considered for elucidation purposes. FIG. 7 shows that, according to the USB standard in the “low-speed mode”, the lines D+ and D− are connected to ground with the resistance R3. The value of the resistance R3 is approximately 15 kohm±the tolerance specified in the USB standard specification.

In accordance with FIG. 2, the detector circuit 8 thus determines which of the signal lines 5 are terminated with the resistances R3, that is to say with approximately 15 kohm. As can be gathered from FIG. 8, in the so-called “full-speed mode”, the same resistances are terminated with the signal lines D+ and D− in accordance with the specification of the USB standard. If the detector circuit has consequently determined the two lines D+ and D− in accordance with the USB standard, which are the lines 5D+ and 5D− in accordance with FIG. 2, initially there is no difference apparent to it, whether operation is effected in the “low-speed mode” or in the “full-speed mode”. In accordance with the exemplary embodiment described here, the detector circuit 8 first of all makes the assumption of one of the two lines 5D+ and 5D− that it is the D+ line in accordance with the USB standard. If the detector circuit 8 then likewise assumes the “low-speed mode”, then a resistance R2 connected to the operating voltage VCC is connected to the assumed D− line, which is the line 5D− in the exemplary embodiment in accordance with FIG. 2, by means of a switching device 6 at the device end. The detector circuit 8 thus attempts to produce an arrangement such as is illustrated in FIG. 7.

If the interface controller 7 then ascertains that the expected protocol does not correspond to that which has been received, this means that the assumption about D+ and D− has been made incorrectly. In accordance with the exemplary embodiment described, the USB connection is interrupted and the detector circuit 8 then causes the switching device 6 at the device end to interconnect the other signal line with the resistance R2. It may furthermore be provided that all the remaining signal lines are prevented, that is to say not continued, by means of the switching device 6.

If the detector circuit 8 assumes a “full-speed mode” in accordance with the USB standard, then it will cause the switching device 6 at the device end to produce an arrangement such as is illustrated in FIG. 8. FIG. 9 illustrates the conditions for a “high-speed mode” that are provided in accordance with the USB standard. This means that at the host end a 15 kohm resistance, that is to say R3, must be connected to ground with the D− line and the signal line D+ must be connected to the operating voltage VCC with a 1.5 kohm resistance. At the device end, it is provided that a 15 kohm resistance, that is to say R1 is connected to ground. Since a highest possible flexibility is to be ensured, the switching device at the device end must consequently be formed in such a way that it can interconnect each of the signal lines 5 either to ground with a resistance R1 or to VCC with a resistance R2 in order to be able to represent one of the three modes illustrated in FIGS. 7 to 9 at the device end for USB operation. Conversely, at the host end, that is to say on the part of a terminal, if the intention is to enable all three modes provided in accordance with the USB standard, it must likewise be possible, by means of the switching device S to connect to each line 5, either the resistance R4 or the resistance R3 which are in each case connected either to the operating voltage or to ground.

To summarize once again, in order to provide a better understanding, if the USB mode is provided, the two lines D+ and D− that are led to the interface contacts 2 are determined and functionally continued by means of the detector circuit 8 and the switching device 6 at the device end. The detector circuit 8 then initially defines, at the device end, which of the lines is D+ and which is D− and causes the switching device at the device end to perform the matching interconnection. If the interconnection provided is incorrect that is to say the protocol is not as expected, then the USB operation is interrupted, the interconnection via the switching device 6 at the device end is interchanged and operation is taken up anew. If the “high-speed mode” is desired in USB operation, then the “full-speed mode” has to be adopted beforehand. In other words, if the “full-speed mode” is formed, then device and host agree that a transition to the “high-speed mode” is to be effected. This is effected in accordance with the USB protocol and both host and device cause the interconnection in accordance with FIG. 9 to be effected in each case via the switching device S at the host end and switching device 6 at the device end.

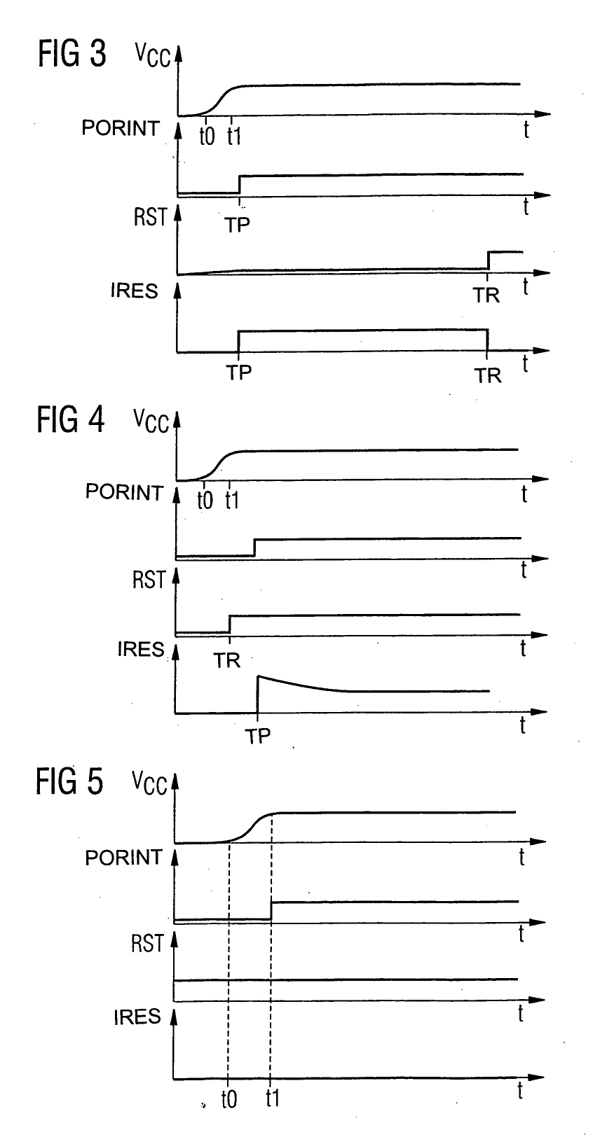

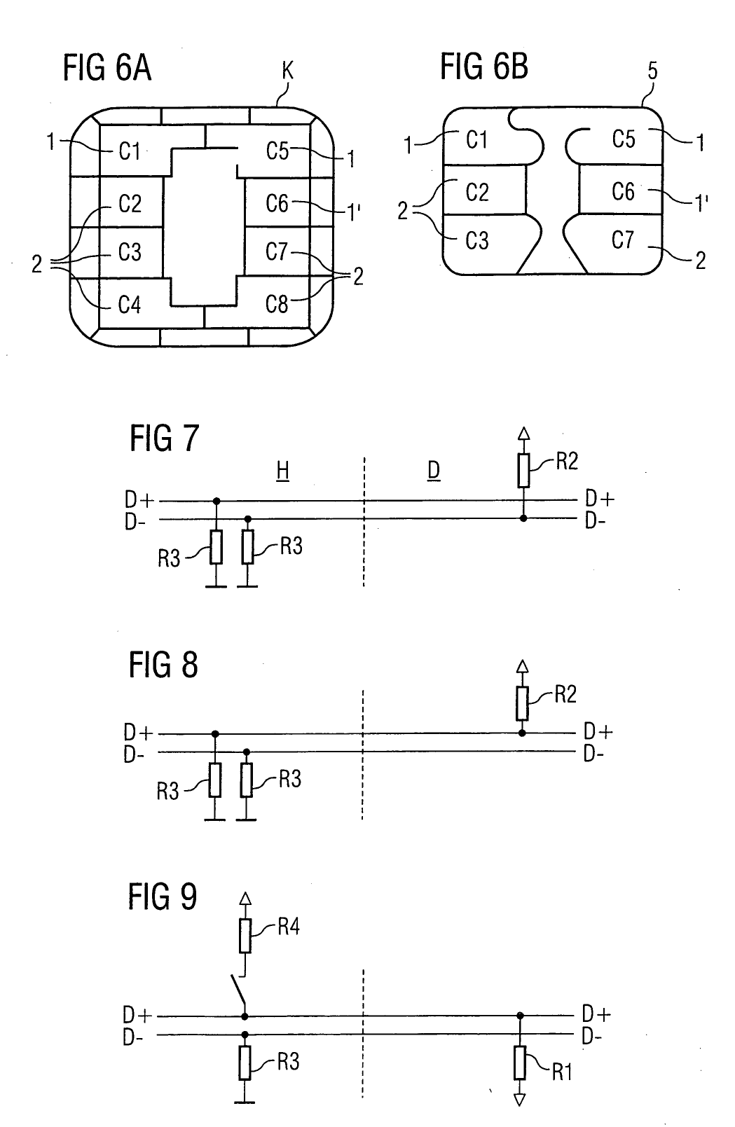

It was previously assumed, that, in accordance with the exemplary embodiment illustrated in FIG. 1 and FIG. 2, at the host end a terminal is provided for operation both in accordance with the ISO smart card standard and in accordance with the USB standard. Both operating modes are likewise intended to be possible at the device end. Terminals that are provided for smart card operation according to the ISO standard usually identify that a card is read into the terminal. If this is ascertained at the terminal end, firstly the potentials for the operating voltage provided are applied to the contacts in accordance with the ISO standard. This means that the contacts at which the operating voltage is transmitted are defined. Accordingly, in accordance with the exemplary embodiment illustrated in FIG. 2, the detector circuit 8 is likewise connected to the two operating voltage lines 4 illustrated, which accordingly, as is illustrated in FIG. 6a and FIG. 6b, are contact-connected for a smart card with the contacts C1 and C5. When a card is pushed into the card terminal, the operating voltage is applied to the contacts C1 and C5 at the host end, that is to say at the terminal end, in other words the operating voltage is switched on. This is illustrated in FIG. 3, FIG. 4 and FIG. 5.

FIG. 3 illustrates, then that a so-called dual terminal operating in the two modes described in accordance with the exemplary embodiment is provided, which initially takes up operation in a smart card operating mode according to the ISO standard. This means that via the smart card contact C2 (see FIGS. 6a, 6b), on the part of the host, that is to say the terminal, a reset signal RST is transmitted via the line 5R in FIG. 2, that means one of the interface signal contacts 2 in FIG. 1.

After a rise in the operating voltage, a so-called “internal power on reset” PORINT is carried out at the device end, in the chip of the smart card in accordance with the ISO standard for smart cards. In other words, a requisite signal is set from 0 to 1 within the smart card chip. If this is effected before the terminal communicates the reset signal RST, then the device, that is to say the smart card chip, identifies that the smart card mode according to the ISO standard is prescribed on the part of the host, that is to say the terminal. In detail, this is identified from the fact that when the power on reset signal “PORINT” rises from 0 to 1, an internal signal IRES is likewise set from 0 to 1 and is reset from 1 to 0 with the reception of the reset signal RST from the terminal. This means that if the chip determines a signal profile IRES between the instants TP and TR such as is illustrated in FIG. 3 for IRES, it is stipulated that a smart card mode according to the ISO standard is initially provided. If the reset signal RST on the part of the terminal arrives before the “power on reset” PORINT is effected, the result is an internal profile of the signal IRES such as is illustrated in FIG. 4. This means that the instant TR precedes the instant TP, which signals to the chip of the detector circuit that USB operation is provided on the part of the terminal. If this has been ascertained, the corresponding lines D+ and D− are subsequently determined by detector circuit 8 and the switching device 6 is used to stipulate the provision of the interconnection suitable for the respective speed mode.

FIG. 5 shows an illustration corresponding to FIGS. 3 and 4 which results if a device that is provided only for USB operation is provided at the host end. No reset signal is provided in accordance with the USB standard. In such a case, the terminal, or the host, would not output a reset signal; that is to say that the signal line 5 at the device end which is connected to the contact C2 at the signal contacts 2 remains at a high level through the pull-up resistor connected to this contact at the card end and the absence of the reset signal can be explicitly detected. At the device end, a “power on reset” PORINT is carried out after the driving of an operating voltage has been ascertained. From the absence of the reset signal, the detector circuit identifies that the terminal operates only in the USB mode.

In accordance with the above description it is evident that, for two-mode operation only the contacts according to the ISO standards C1, C5 and C2 are necessary for the transmission of the operating voltage and the reset signal. In the case of an eight-contact smart card contact array as is illustrated in FIG. 6a, the remaining contacts are available at least as signal lines and/or as interface signal contacts. The contact C6 would optionally also be available. This contact is provided for the transmission of a programming potential in accordance with the ISO standard. Therefore, this contact is also provided with the reference symbol 1′ in accordance with FIG. 6a. However, since the programming voltage is generated internally on the chip itself, in present-day customary operation, and the transmission of a programming potential is therefore generally not necessary, the contact C6 could ultimately also be available for the signal line. Accordingly, in the case of a six-contact smart card contact array as illustrated in FIG. 6b, the contacts C3, C7 and if appropriate C6 are ready for selection.

This means that, in accordance with the arrangement according to FIG. 1 or FIG. 2, the detector circuit 8 checks all signal lines 5 that lead to the interface signal contacts 2, which represent the contacts C3, C4, C7, C8, if appropriate C6 (C3, C6, C7 in accordance with FIG. 6b) in respect of what interconnection is provided at the host end. If this has been effected, a corresponding interconnection is carried out via the internal switching device 6, as described above.

The exemplary embodiment explained above describes operation using the contacts for smart cards in accordance with the ISO standard both in the ISO mode that is customary for smart cards and in the faster USB mode.

However, the scope of the invention also encompasses the fact that other mechanical contacts and other data transmission protocols to which the general concept can be applied come under the invention.

1. A line-conducted interface arrangement comprising:
at least three signal lines connected between a host and a device;
a detector which is connected to the signal lines at a device end of the interface arrangement, and detects an interface configuration prescribed at the host; and
a switch controlled by the detector to adapt the device to the interface configuration prescribed at the host.

2. The interface arrangement as claimed in claim 1, wherein the detector distinguishes between at least two different interface standards.

3. The interface arrangement as claimed in claim 2, further comprising at least two predetermined lines for transmitting at least a first operating potential and a second operating potential, the monitoring of which is performed by the detector in order to determine the at least two different interface standards.

4. The interface arrangement as claimed in claim 2, wherein the at least two different interface standards are the USB and ISO 7816 standards.

5. The interface arrangement as claimed in claim 1, wherein the detector comprises an apparatus that determines a terminating resistance of the at least three signal lines.

6. The interface arrangement as claimed in claim 1, wherein the switch connects at least two different potentials via a respective predetermined resistance in accordance with a predetermined interface configuration.

7. The interface arrangement as claimed in claim 1, wherein the detector has a voltage detector that detects at least a rise in an operating potential from a first potential magnitude to a second potential magnitude.

8. A method for operating a line-conducted interface arrangement connected between a host and a device, for at least two different interface standards, comprising the steps of:
after the host has been contact-connected to the device, the device ascertaining, on two predetermined signal lines, a presence of an operating voltage made available by the host; and
the device then determining, by monitoring a reset signal line, an operation for which the host is provided, in accordance with the at least two different interface standards.

9. The method as claimed in claim 8, further comprising the step of, upon ascertaining no change in a signal level on the reset signal line beyond predetermined limits, assigning the host sole operation in the first of the at least two interface standards provided.

10. The method as claimed in claim 8, further comprising the steps of, upon ascertaining a signal change on the reset signal line above a predetermined threshold before an internal reset is effected in the device,
assigning the host a multiple standard property; and
effecting the operation in the first of the at least two interface standards.

11. The method as claimed in claim 8, further comprising the steps of, upon ascertaining a signal change on the reset signal line above a predetermined threshold after an internal reset signal of the device takes effect,
assigning the host a multiple standard property; and
effecting the operation in the second of the at least two interface standards.

12. The method as claimed in claim 8, further comprising the step of determining a functional assignment in accordance with a first standard from two data lines by measuring a terminating resistance.

13. The method as claimed in claim 12, further comprising the steps of, after determining the functional assignment from the two data lines,
assuming a functionally more precise assignment;
if the assumption is correct, maintaining the more precise assignment; and
if the assumption is incorrect, changing the assignment by interchanging the two data lines.
